(19) United States
(12) Patent Application Publication
(10) Pub. No.: US 2016/0043771 A1
(43) Pub. Date: Feb. 11, 2016

(54) WAFER SCALE. ULTRA-WIDE BAND (UWB) RADIOMETER WITH SENSOR PROBE FOR DISASTER VICTIM RESCUE

(71) Applicant: Farrokh Mohamadi, Irvine, CA (US)

(72) Inventor: Farrokh Mohamadi, Irvine, CA (US)

(21) Appl. No.: 14/822,504

(22) Filed: Aug. 10, 2015

Related U.S. Application Data
(60) Provisional application No. 62/035,032, filed on Aug. 8, 2014.

(51) Int. Cl. H04B 1/7163; G01S 19/10; G01S 19/05; H04W 4/02; G08B 5/36

(52) U.S. Cl. CPC H04B 1/7163; H04W 4/02; G08B 5/36; G01S 19/05; G01S 19/10

(57) ABSTRACT

A multi-sensor system is disclosed for detecting victims that may be trapped or buried (for example, earthquake survivors in collapsed buildings) and for accurately and safely locating such victims for safe and efficient rescue. An ultra wide band (UWB) radiometer sensor can detect and precisely calculate the position of the victim relative to a known position of a sensor probe or a monitoring unit of a sensor system. A sensing probe may be guided toward a victim and provide a combination of sensors and transducers (e.g., radiometer, optical and infrared camera, acoustic or sound transducers such as microphone and speaker) that may allow a probe operator remote from the subject (e.g., victim) to also determine the condition and status of the victim and communicate with the victim. With unique coding of the UWB signals, multiple units can be used together to triangulate a more exact position of each victim.

### CROSS REFERENCE TO RELATED APPLICATIONS

This application claims the benefit of priority from U.S. Provisional Patent Application No. 62/035,032, filed Aug. 8, 2014, which is incorporated by reference.

### TECHNICAL FIELD

Embodiments of the present invention generally relate to combined sensing systems for detecting living subjects and, more particularly, to a portable system that combines optical, audio, and radiometer imaging systems with global positioning (GPS), accelerometer, and magnetometer positioning for locating living subjects such as trapped victims of earthquakes and other disasters.

### BACKGROUND

There is often a need for detection of people who may be hidden behind or trapped underneath building rubble, concealed behind walls, or obscured by smoke-filled rooms. Such a situation can arise, for example, after a building collapse due to earthquake, when the search is for victims injured, trapped, or buried underneath building rubble whose lives may be in danger and for whom the time it takes to be found may be critical. Similar situations also may arise due to fire, flood, plane crashes, or other catastrophes.

For urban and other search and rescue teams (generally referred to as “first responders”), a number of sensing capabilities and technologies have been developed such as canines (e.g., specially trained dogs), listening devices, and video cameras to detect the presence of living victims who may be hidden and trapped or otherwise unable to move. Similar capabilities may even be useful for combat teams in a war zone when the search may be for hostile individuals.

Despite the development of such capabilities and technologies, a need still exists not only for detecting victims but for accurately locating them for safe and efficient rescue.

### BRIEF DESCRIPTION OF THE DRAWINGS

FIG. 1 is a perspective view physical diagram showing operation of a sensor system for detecting and locating victims trapped in a pile of rubble, according to one embodiment.

FIG. 2 is perspective view of illustration of a monitoring unit and sensor probe with portable carrying case of a sensor system in accordance with one or more embodiments.

FIG. 3 is a system block diagram illustrating a radiometer sensor for detecting and locating a subject (e.g., disaster victim) in accordance with one embodiment.

FIG. 4 is a cross sectional physical diagram for a sensor probe, according to one embodiment.

FIG. 5 is a cross sectional physical diagram for a sensor probe, according to another embodiment.

FIG. 6A is a system block diagram illustrating a monitoring unit and sensor probe of a sensor system in accordance with one embodiment.

FIG. 6B is a system block diagram illustrating a monitoring unit and sensor probe of a sensor system in accordance with another embodiment.

FIG. 7 is a system block diagram illustrating guidance and movement features for a monitoring unit and a sensor probe of a sensor system in accordance with an embodiment.

FIG. 8 is a flow chart illustrating a method for signal processing for guiding a sensor probe through obstacles for searching for a subject, in accordance with an embodiment.

FIG. 9A, 9B, 9C, 9D, and 9E are illustrations of touch-screen image displays for a user interface of a sensor system in accordance with one or more embodiments.

FIG. 10 is a graph illustrating insertion loss vs. frequency for a 16-by-16 LHCP antenna array, such as that shown in FIG. 5, in accordance with an embodiment.

FIGS. 11A and 11B are graphs showing co-polarization and cross polarization for wafer scale, LHCP and RHCP antenna arrays, in accordance with an embodiment.

FIG. 12 is a graph showing an example of polarization and enhancement of side lobe suppression for a four-by-four element collimated antenna array, in accordance with an embodiment.

FIG. 13A is a diagram showing a cross section of a collimator for an antenna array, in accordance with an embodiment; and FIG. 13B is a perspective diagram of a collimator and a pair of two-by-two element collimated antenna arrays, in accordance with an embodiment.

Embodiments of the present disclosure and their advantages are best understood by referring to the detailed description that follows. It should be appreciated that like reference numerals are used to identify like elements illustrated in one or more of the figures, in which the showings therein are for purposes of illustrating the embodiments and not for purposes of limiting them.

### DETAILED DESCRIPTION

Embodiments of the present disclosure address a persistent need for capabilities and technologies for detecting victims that may be trapped or buried (for example, earthquake survivors in collapsed buildings, fire, flood, and even avalanche victims) and for accurately and safely locating such victims for safe and efficient rescue. One or more embodiments provide means for detecting the presence of a subject (e.g., victim) in such situations and precisely locating (e.g., establishing and precisely calculating the position of the subject relative to a known position of the sensor or rescuer) the subject for purposes such as safely getting to the subject and safely rescuing the subject. A sensing probe, according to one or more embodiments, may provide a combination of sensors and transducers (e.g., radiometer, optical and infrared camera, acoustic or sound transducers such as microphone and speaker) that may allow a probe operator remote from the subject (e.g., victim), in addition to detecting the presence of the victim and establishing a precise location of the victim, to also determine the condition or status of the victim and even communicate with the victim.

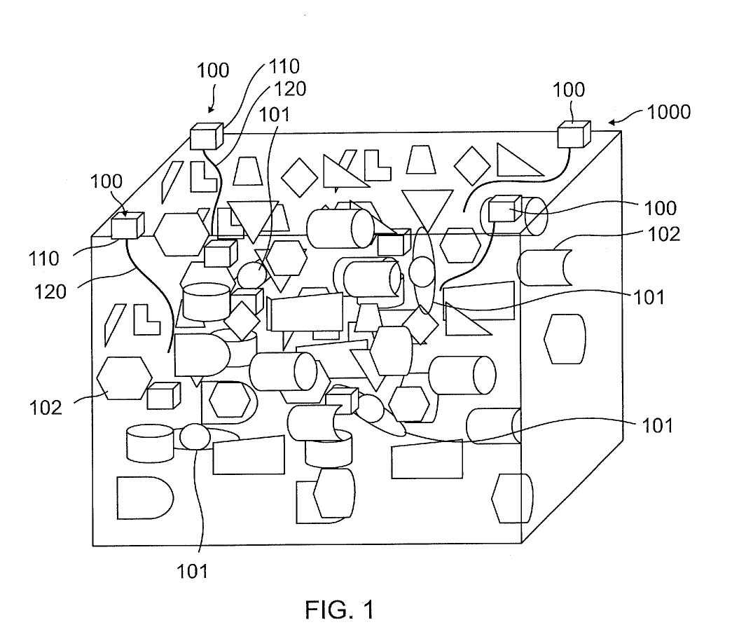

FIG. 1 is a perspective view physical diagram showing operation of a sensor system 1000 for detecting and locating subjects 101 (e.g., victims) trapped in a pile of rubble 102 (schematically indicated by various geometric shapes) using an earthquake disaster situation of a collapsed building structure producing rubble 102 trapping and obscuring subjects or victims 101 as an example for illustration.

Sensor system 1000 may include a multitude of monitoring and sensor units 100 as shown. Each monitoring and sensor unit 100 may simply be placed on the ground or rubble as shown, or may be mounted on tripods for more adjustability or security in locating each unit. Each monitoring and sensor unit 100 may include a monitoring unit 110 and a sensing probe 120. Each monitoring and sensor unit 100 may include a sensing probe 120 that uses a narrow, long, probe with UWB antenna tip that can be inserted into the rubble 102 (or other material such as mud or snow, depending on the situation) as shown. The sensing probe 120 may be integrated with the UWB radiometry system (monitoring and sensor unit 100) to operate in the 1-10 Giga Hertz (GHz) bandwidth range (or higher bandwidth and frequency ranges as further described below).

Sensing probe 120 (which may include a local multi-directional or directional antenna system) may be inserted inside the cavity (e.g., hollow spaces between rubble 102) and routed to any depth (depending on the building levels that produce rubble 102). In one embodiment, sensing probe 120 may be “snaked” into the hollow spaces in much the same way that a plumber may use a plumber's snake or that electricians may route wire through confined spaces. In another embodiment, sensing probe 120 may incorporate or be mounted on some form of motive device such as a wheeled robotic vehicle or crawler type of robot to move the sensing probe 120 through the rubble 102. After insertion into the rubble 102, sensing probe 120 may be turned on to transmit UWB impulses that transmit and collect reflections of the transmitted signal.

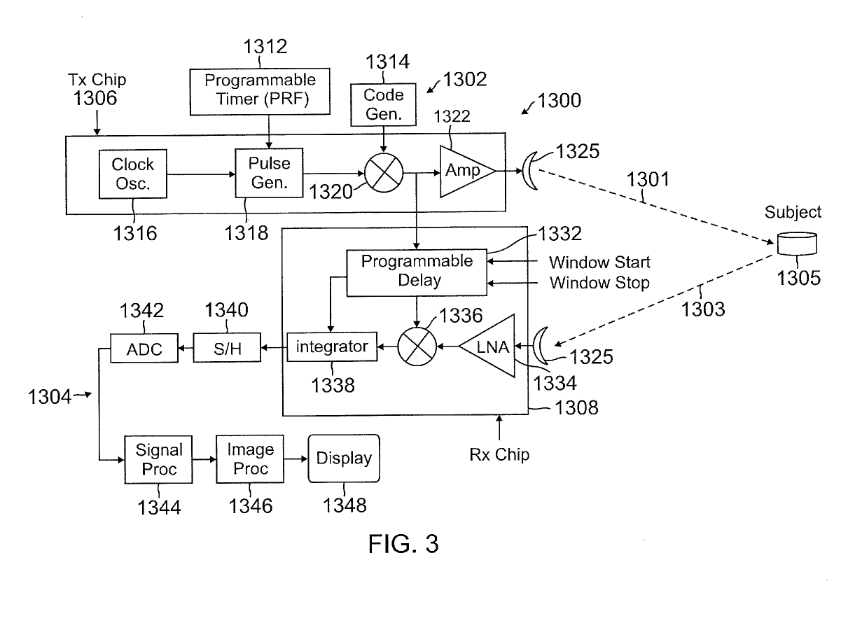

In accordance with various embodiments, the sensor (e.g., antenna of sensing probe 120 and radiometer sensor 1300, see FIG. 3) can produce very fine (narrow or highly directional) beams in aggregate of miniature antennas as a very directional search tool using the V- or W-bands using beam forming techniques disclosed herein or incorporated by reference. As an example, using UWB impulse radiometry, a single wire end-fed antenna with less than 10 dB attenuation over the impulse band can be used to match with a +1 dBm, 3-6 GHz transmitter. In the example, the measured bandwidth is 2-6 GHz, while a 40 dB loss due to the connecting wires (e.g., cable 125 of sensing probe 120) were used to calibrate the antenna loss. The transmitted signal has naturally a very low range of 25 ft. in line-of-site as adjusted insertion loss.

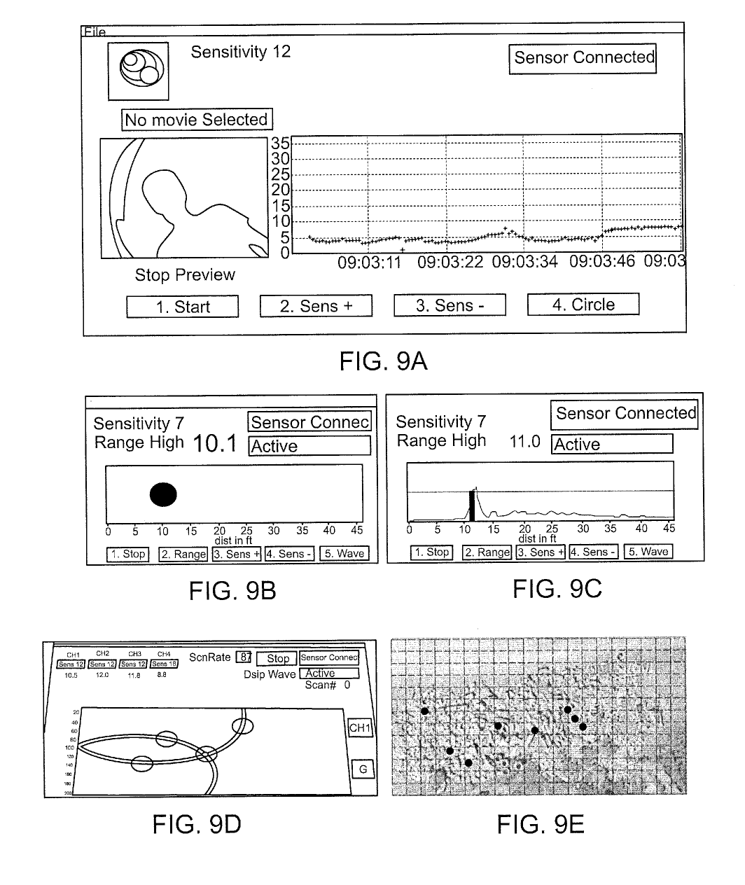

Signal and image processing algorithms may be employed to construct a 2-dimensional image of the subject (see e.g., FIG. 9A); thus, the sensor (monitoring and sensor unit 100) can estimate its distance of detected breathing to the sensor's probe (sensing probe 120) from the time delay between transmitted pufses to the received ones.

Using an extended probe (sensing probe 120) can provide more sensitivity due to its proximity to the breathing subject and less interference from surface noise. Additionally, a sensing probe 120 may integrate various sensors and transducers, such as a micro-electromechanical systems (MEMS) microphone, to provide the capability of hearing the voice, breathing, or other sounds made by a trapped person and may include a mini camera and series of LED lights that enable viewing the trapped person when in line-of-site (LOS) of the sensing probe 120.

The spatial change of propagating waves can provide vicinity location of the victim at the depth of the sensing probe 120. The multipath reflection may also be helpful in detecting and locating a living victim. For example, the radiometer can detect movement or breathing of a person or animal in a non-line of sight situation within a cavity. One method is by multipath 1st, 2nd and 3rd order reflections due to the walls (e.g., rubble surfaces) of the cavity. A description of multipath detection of movement or breathing of a person or animal may be found in U.S. Pat. No, 8,779,966, issued Jul. 15, 2014, to Mohamadi et al., which is incorporated by reference.

The transmitted signals or pulses of multiple monitoring and sensor units 100 may be provided with a mutually exclusive coding. For example, each radiometer transmitting unit for a monitoring and sensor unit 100 may include a signal generator using pseudo-random bit sequence (PRBS) coding generators or a Hadamard coding of the pulse signal that can be identified from the reflected signal. Thus, each of the multiple monitoring and sensor units 100 may be able to distinguish its own reflections from that of all the other monitoring and sensor units 100. All of the monitoring and sensor units 100 can then operate simultaneously without interfering with each other. Position calculations from multiple monitoring and sensor units 100 can be combined to provide accurate locating of the victims 101 (subject of search). For example, triangulation using data from multiple monitoring and sensor units 100 can help pinpoint a more accurately the exact location of a victim.

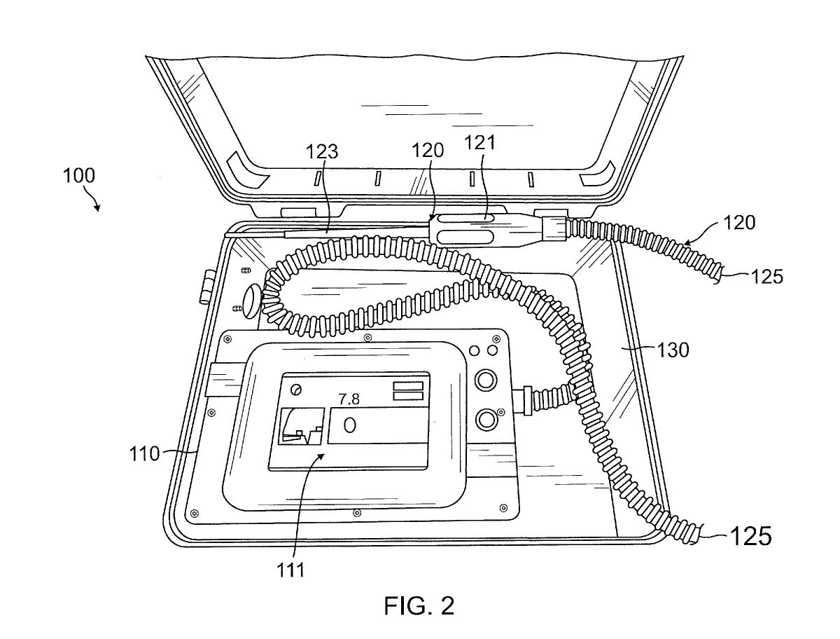

FIG. 2 illustrates one physical embodiment of a monitoring and sensor unit 100 including a monitoring unit 110 and a sensing probe 120 with portable carrying case 130 of a sensor system 1000 in accordance with one or more embodiments.

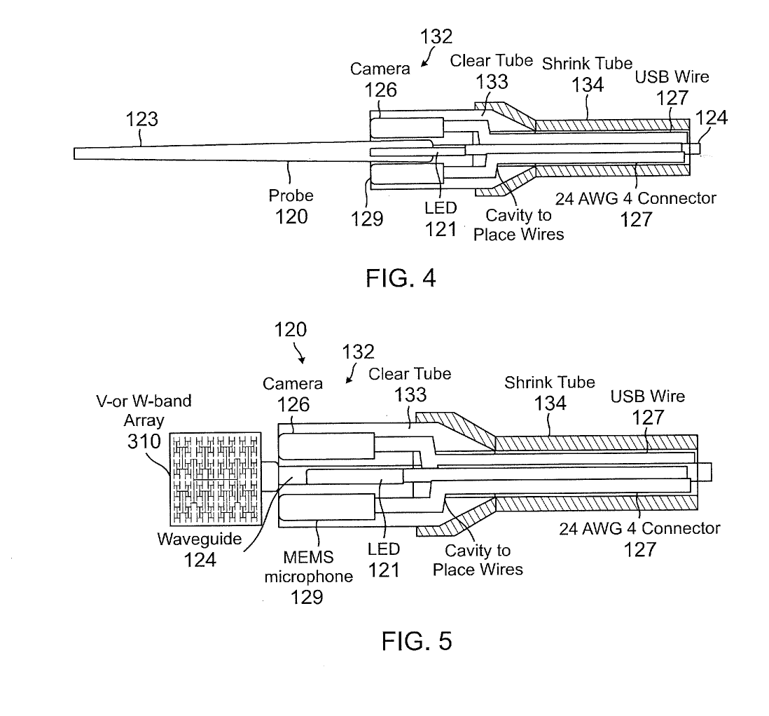

As shown in FIG. 2, sensing probe 120 may include a cable 125 for extending or moving the probe in addition to communicating with sensors and transducers of sensing probe 120, an array of light emitting diodes (LED array) 121, two micro cameras (shown in FIGS. 4 and 5), and a dipole antenna 123; and monitoring unit 110 may include an integrated tablet 111. A software application executing on tablet 111 may receive digital signal processing (DSP) processed data from the sensor (e.g., radiometer sensor 1300 shown in FIG. 3) and provide additional signal processing to calculate the distance of the trapped or hiding person (e.g., subject or victim 101) to the sensing probe 120 of the sensor. In addition to a camera and LED lighting, a highly sensitive cardioid (heart shape) directional beam can be used to detect the slightest voice or sound of movement in the direction of a cardioid MEMS microphone 129 (shown in FIGS. 4 and 5) or other microphone or acoustic transducer having a cardioid (for example) or other directional field sensitivity pattern. The distance to the live subject and the lightened area view may be displayed on a large waterproof display screen of tablet 111. The touch control function of the tablet 111 screen can allow exploring functionalities of the sensor 100 such as increase and decrease in sensitivity of detection, changing range of detection for more focusing on the subject, and choice of viewing dot, icon, or waveform displays for more detailed analysis of breathing, heartbeat, motion detection, and monitoring. The tough outdoor case 130 may also protect the monitoring and sensor unit 100 when deployed in harsh environments.

FIG. 3 illustrates a radiometer sensor 1300 in accordance with an embodiment. Radiometer sensor 1300 may include an impulse radiometer transmitter 1302 that transmits narrow radio frequency (RF) pulses at a certain pulse repetition frequency (PRF). For example, the transmitter of radiometer sensor 1300 may emit RF radiation 1301 in the form of rapid wideband (narrow width) radiometer pulses at a chosen pulse repetition frequency (PRF) in the 1-10 GHz band. The ultra wideband (UWB) radio frequency (RF) sensor emits rapid low power (less than 1/1000 power of a cell phone) pulses that travel through air and get reflected (bounced back) from glass, wood, concrete, dry wall and bricks. By choosing a PRF in the range of 10-100 MHz, for example, and appropriate average transmitter power, a surveillance range of approximately 5-50 feet can generally be achieved. The radiometer system 1300 may, for example, transmit Gaussian pulses as short as 100 picoseconds (ps) wide with center frequency in the 1-10 GHz band.

In one or more embodiments, the UWB millimeter-wave radiometer sensor system 100 may operate with sub-200 picosecond bipolar pulses. The sensor 1300 may utilize the unlicensed 1-10 GHz band up-converted and down-converted to V-band (e.g., 60 GHz). An adjustable PRF in the range of 1-10 MHz may achieve an unambiguous range of up to 50-100 ft. The range resolution may be about 30 millimeters (mm). The received power may be digitally processed to extract relevant information on the reflecting object (e.g., distinguishing trapped person from “rubble” walls). In another embodiment, sensor 1300 may operate at the W-band (e.g., about 75-110 GHz).

Each monitoring and sensor unit 100 may include radiometer sensing (radiometer sensor 1300) with augmented capabilities based on implementation of an ultra wide-band core (UWB), operating in the license free band (e.g., 1-10 GHz) band. The UWB radiometry may be enhanced and miniaturized based on spatial beam forming and combining at V-band (e.g., about 40-75 GHz), E-band (e.g., including two bands of about 71-76 and 81-86 GHz), or W-band (e.g., about 75-110 GHz). One or more embodiments may include implementation of a planar active array transmitter (TX) fully integrated with an array of power amplifiers (PA) and corresponding antenna arrays to form spatial power combining and beam forming. One or more embodiments may include implementation of a planar active array receiver (RX) fully integrated with an array of low noise amplifiers (LNA) and corresponding antenna arrays to form spatial power combining from the narrow beam transmitter, Some embodiments provide further miniaturization of each sensor (generally 2 to 4 sensors, for example, may be used in each system) to operate at the W-band. For example, the system can employ a single sensor or a quad sensor (comprising, e.g., four sensors) for detection of individuals.

Radiometer sensor 1300 may employ a wafer scale antenna and wafer scale beam forming as disclosed in U.S. Pat. No. 7,312,763, issued Dec. 25, 2007, to Mohamadi and U.S. Pat. No. 7,548,205, issued Jun. 16, 2009, to Mohamadi; virtual beam forming as disclosed in U.S. Pat. No. 8,237,604, issued Aug. 7, 2012, to Mohamadi et al., and using respiration and heartbeat as well as spectral analysis at 60 GHz for detection of individuals as disclosed in U.S. Pat. No. 8,358,234, issued Jan. 22, 2013, to Mohamadi et al., all of which are incorporated by reference.

Radiometer sensor 1300 may include a radiometer receiver 1304 that performs the required signal processing on a reflected response (e.g., reflected pulses 1303) to construct a digitized representation of the subject 1305. In the receiver 1304, a detector circuit (e.g., signal processing 1344) may be employed to identify the reflections. The received signal 1303 may be compared sequentially in near real-time to the previous one and then recorded. If deviation from the previously recorded electro-magnetic spatial map of open space is observed, the signal processing 1344 may interpret that as an existence of breathing. In the receiver 1304, amplitude and delay information may be extracted and digitally processed. As shown in FIG. 3, many of the transmitter 1302 functions may be implemented on a transmitter chip 1306 and many of the receiver 1304 functions may be implemented on a receiver chip 1308.

A general block diagram of transmit and receive functions are depicted in FIG. 3. As shown in FIG. 3, radiometer sensor 1300 may include modules for performing the functions, including: programmable timer 1312 for establishing the PRF; code generator 1314 for providing modulations to the signal 1301; clock oscillator 1316 for providing the RF carrier frequency signal; pulse generator 1318 for forming (or generating) narrow radiometer pulses based on timing from programmable timer 1312; multiplier 1320 for combining the generated radiometer pulses with the output of code generator 1314; power amplifier 1322 for amplifying the pulse signal and feeding it to antenna 1325, which may a wafer scale, beam forming antenna as described above. Although two antennas 1325 are shown in FIG. 3 for clarity of illustration, use of a circulator (not shown) as an isolator switch may enable use of a single antenna 1325 for both transmit and receive. Antenna 1325 may include an active array antenna implemented using wafer scale antenna module and virtual beam forming in ultra wideband systems technologies.

Virtual beam forming in ultra wideband systems is disclosed by U.S. Pat. No. 8,237,604, issued on Aug. 7, 2012 to Mohamadi et al.; wafer scale antenna module (WSAM) technology is disclosed by U.S. Pat. No. 7,884,757, issued Feb. 8, 2011, to Mohamadi et al. and U.S. Pat. No. 7,830,989, issued Nov. 9, 2010 to Mohamadi, all of which are incorporated by reference.

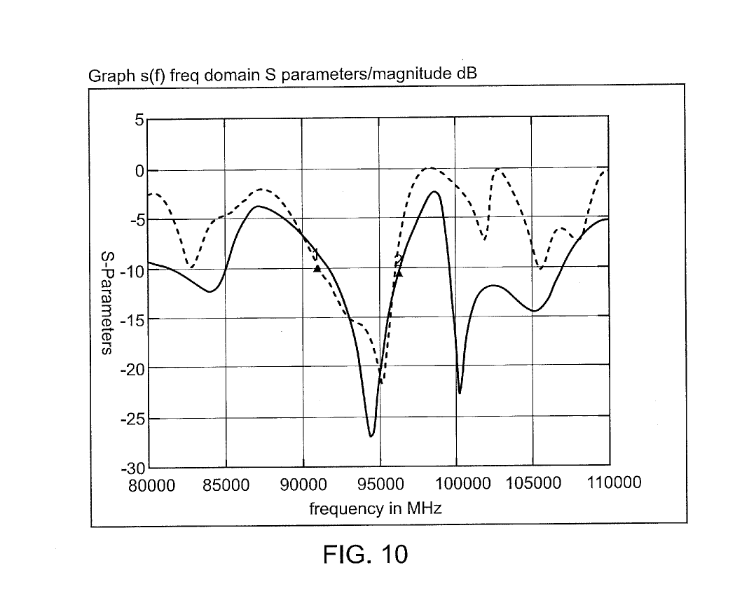

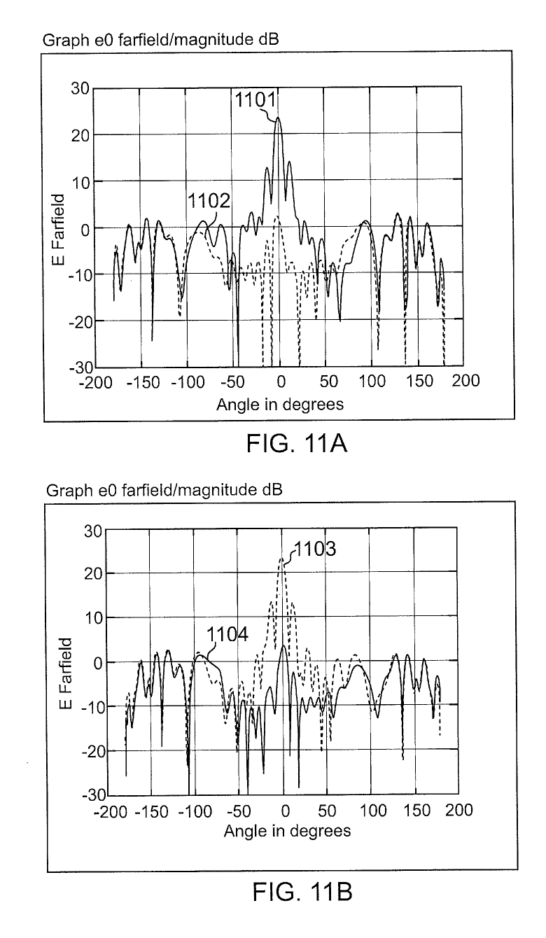

Radiometer sensor 1300, as shown in FIG. 3, may further include modules for performing functions, including: programmable delay timer 1332, coordinated with the transmitted signal 1301, as indicated by the arrow between transmitter chip 1306 and receiver chip 1308, for providing timing, e.g., window start and window stop, for receiving reflected pulses 1303; a low noise amplifier 1334 for receiving the reflected pulses 1303; multiplier 1336 for combining the received reflected pulses 1303 and the window delay from programmable delay timer 1332; integrator 1338; sample and hold 1340, analog to digital converter 1342; signal processor 1344 (e.g., a digital signal processor or DSP); image processor 1346; and display 1348. Display 1348 may be as shown for example in FIG. 10 or FIG. 11.

FIG. 4 illustrates one embodiment for sensing probe 120. Sensing probe 120 may include a dipole antenna 123 in communication with a waveguide 124. Waveguide 124 may extend through cable 125 (shown in FIG. 2) to communicate radio frequency signals between antenna 123 and a radiometer sensor such as radiometer sensor 1300, shown in FIG. 3, which may be included in monitoring unit 110. LED array 121 may be used to light an underground or hard to view cavity, e.g., space within the rubble 102 as seen in FIG. 1, for viewing or recording with one or more cameras 126. Cameras 126 may include multiple micro cameras 126 embedded or mounted inside the probe head 132 which may include a clear tube 133 surrounding the various components—such as cameras, LED lights, microphones, speakers, and cable connections of those components—for protecting the components and allowing functioning of the lights and cameras. Additional protection may be provided by shrink tubing 134 or other casing material surrounding the probe head 132 and end of cable 125. Cameras 126 and other electrical sensor and transducer components may communicate with monitoring unit 110 via universal serial bus (USB) wiring 127 (or other electrical connectors 127) which may connect the components through cable 125 to monitoring unit 110. Dipole antenna 123 may transmit and receive UWB spectra having a bandwidth of 2-6 GHz, for example. Using dipole antenna 123, the transmitted (received) UWB pulses may be propagated omni-directionally, or by selective coating of an antenna cover (not shown), antenna 123 may provide a cardioid field propagation pattern. The cardioid radiation pattern can be more directional than standard “isotropic” dipole operation, and therefore can be more suitable to pinpoint the distance and the direction of the trapped or hiding person (e.g., subject 101) from the sensing probe 120.

Cameras 126 and LED array 121 may be used to provide an optical display of the subject 101 or the situation of the probe head 132 on the display screen of monitoring unit 110, e.g., display of tablet 111. Additional audio sensors and transducers placed within the probe head 132 may provide the ability to listen from the monitoring unit 110 for noise and communication from a subject (e.g., victim) 101 and to communicate back to a victim or subject 101 from the monitoring unit 110. For example, probe head 132 may include a MEMS directional microphone 129. The MEMS directional microphone 129 may have a cardioid sensitivity pattern for picking up sound. The cardioid radiation pattern of dipole antenna 123 and the cardioid sensitivity pattern of MEMS microphone 129 may be adjusted to overlap so that their maximum propagation or sensitivities point in approximately the same direction. Such an arrangement can improve the detection of a specific location or direction of a subject by using more than one type of sensing in a single direction simultaneously.

Additional components of probe head 132, which may enable various functions for navigating (e.g., both moving and determining the position of) and sensing the environment of probe head 132, may include magnetometers, temperature sensors, infrared cameras, gyroscopes or gyro systems, and accelerometer systems.

FIG. 5 illustrates an alternative embodiment for sensing probe 120 that uses a wafer scale UWB antenna array 510 in communication with waveguide 124. Wafer scale UWB antenna array 510 may use a much higher frequency range than the dipole antenna 123 such that the array of antennas 510 can perform spatial beam forming. Some beam steering may be provided as well, in addition to that provided by movement of the probe head 132. The radiometer sensor (e.g., radiometer sensor 1300) may obtain an ultra high sensitivity as a result of ultra wideband interrogation using a wafer scale antenna array so that providing sensing probe 120 with wafer scale UWB antenna array 510 can enable sensor 1300 to detect the slightest chest movement and even heartbeat of a trapped person or subject 101.

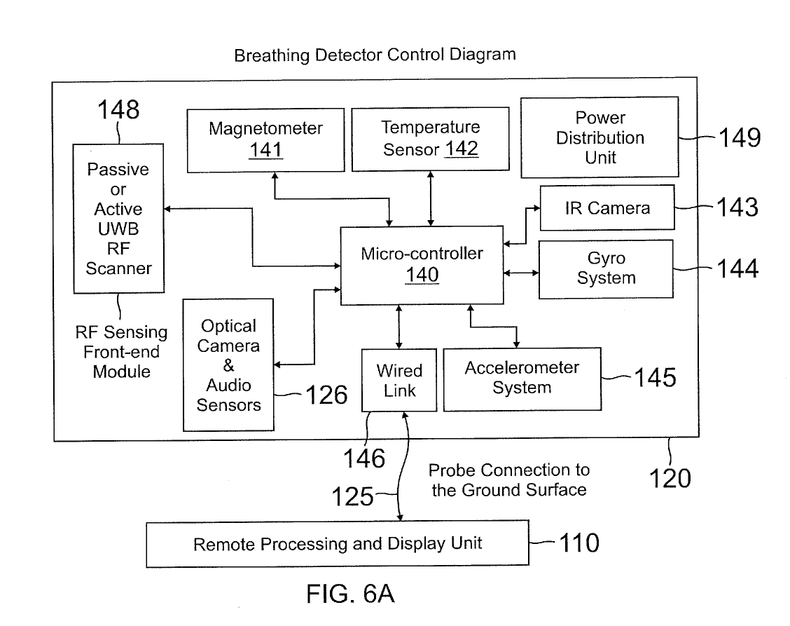

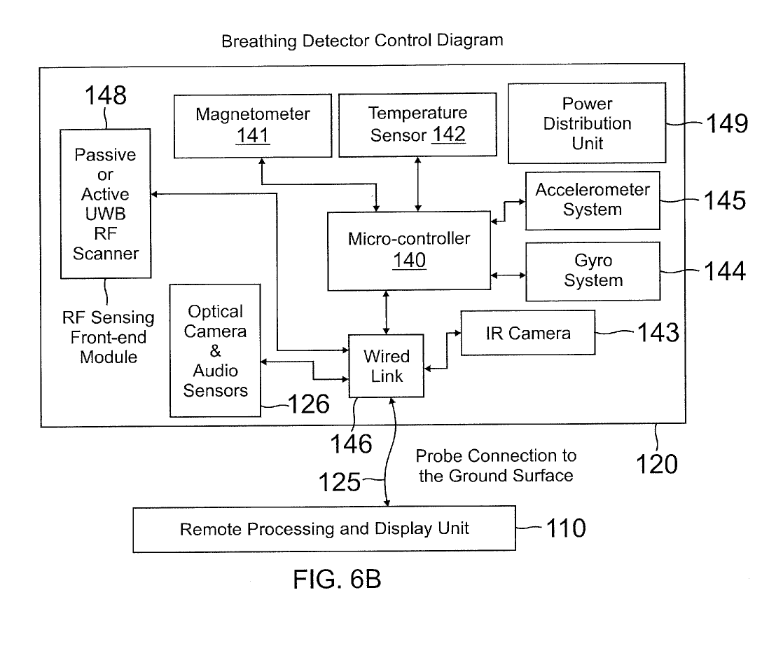

FIG. 6A and FIG. 6B illustrate alternative embodiments for a monitoring unit 110 and sensor probe 120 of a sensor system 100. FIG. 6A illustrates a fully integrated sensor system 100 that can provide a two way audio and video communication with a subject as well as indicating the position of the subject (e.g., trapped person) to the first responders. FIG. 6B illustrates another embodiment of the sensor integration for a fully integrated sensor system 100, in which fewer of the sensor probe 120 functions are shared between the local controller 140 and the remote processor of monitoring unit 110.

Sensing probe 120 may include a radiometer sensor scanner 148 (e.g., dipole antenna 123 or wafer scale UWB antenna array 510 in communication with radiometer sensor 1300). Radiometer sensor scanner 148 may be in communication the remote processor of monitoring unit 110 either through the micro controller 140, as shown in FIG. 6A or directly through wired link 146, as shown in FIG. 6B.

A number of systems and components may be provided for sensing the environment of the probe head 132 of sensing probe 120, such as temperature sensor 142, magnetometer 141, infrared camera 143, and optical cameras and audio sensors 126, all of which may communicate with micro controller 140 or with wired link 146 to provide data to and receive commands from monitoring unit 110 as shown, for example, in FIGS. 6A and 6B, although other arrangements are possible and contemplated by this disclosure. Also a number of systems and components may be provided for moving the the probe head 132 of sensing probe 120 and exactly determining its location as well as the location of a detected subject (e.g., earthquake victims 101). Thus, sensing probe 120 may include magnetometer 141, gyro system 144 and accelerometer system 145. Sensing probe 120 may also include a power distribution unit 149 for providing electrical power to the various systems and components of sensing probe 120. Monitoring unit 110 may include a GPS module for locating the position of monitoring unit 110.

Because GPS is inefficient operating underground, specifically at depths of 50 ft. and below, however, an additional mechanism is needed to address the position of the detected trapped person (e.g., earthquake victim 101). In addition to locating the trapped individuals by UWB radiometer sensor, system 100 may also include technology for guidance and determining location of the probe head 132.

Accelerometer system 145 may include a three axis linear accelerometer. The accelerometer may be used for inclinometer functions, orientation compensation, wake-on-motion, and other operations that can be combined with data from other sensors to provide deduced information not determinable from the sensors separately (referred to as fusion operations). Accelerometer system 145 may also provide calibration data. Any faintest vibration can be detected by accelerometer system 145 that may, in addition to the UWB breathing detector, be able to give a more accurate distance to the trapped person (subject 101) from the sensing probe 120.

Gyro system 144 may include a three axis angular velocity sensor or gyroscope. The gyroscope can measure rotation about the X, Y and Z axes of the UWB sensor (e.g., dipole antenna 123 or wafer scale UWB antenna array 510) attached to the sensing probe 120. Angular velocity can be an input used to produce cursor motion output on the tablet 111 display of monitoring unit 110, general motion output display information, and other outputs resulting from operations combined with other sensors to provide deduced information not determinable from the sensors separately (referred to as fusion outputs).

Magnetometer 141 may include a three axis magnetometer. The magnetometer measures the Earth's magnetic field and can be used to determine absolute orientation. Absolute orientation can be thought of as determining which direction is north. Using the real-time video input from one or more of cameras 126 and the information from the accelerometer system 145, the data can be used to approximate the exact position of the trapped person, starting, for example, from the known GPS position of monitoring unit 110.

The various sensor outputs (e.g., outputs from accelerometer system 145, gyro system 144, and magnetometer 141) may be gathered by sensing probe 120 and transmitted through the cable 125 to the processing unit of monitoring unit 110 at the ground surface, where the first responder can monitor the position of the trapped person and take proper action for rescue operations.

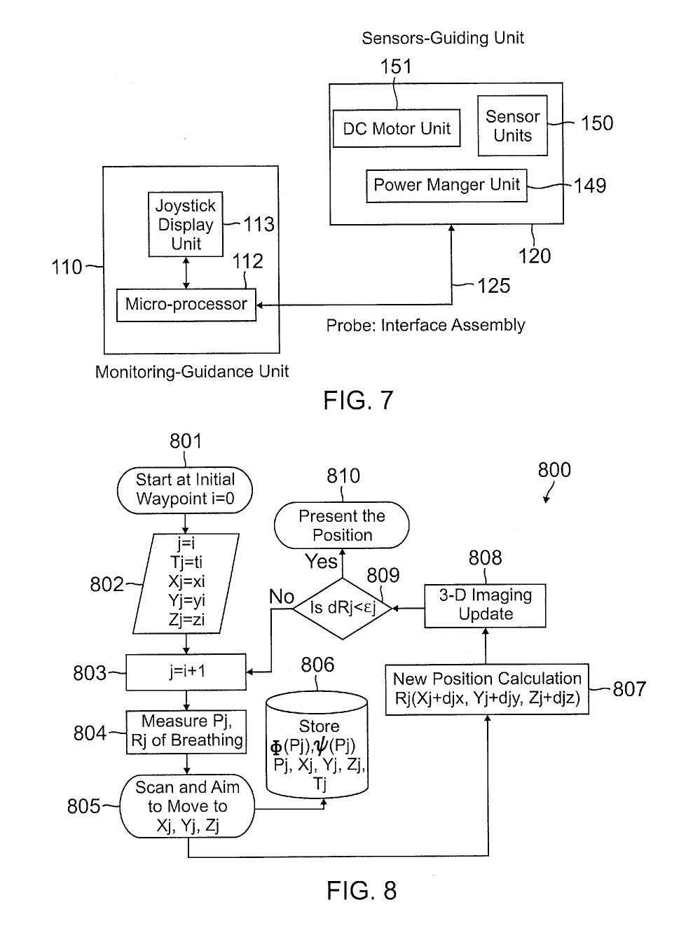

FIG. 7 is a system block diagram illustrating guidance and movement features for a monitoring unit 110 and a sensor probe 120 of a sensor system 100 in accordance with an embodiment. As seen in FIG. 7, monitoring unit 110 may further incorporate a control and display unit for directional guidance of a direct current (DC) motor based micro-robot that carries the sensing probe 120 including the set of sensors of FIG. 6A or FIG. 6B. Monitoring unit 110 may be provided with a joystick control unit 113 that may, for example, be implemented using touch screen display of tablet 111. For example, a microprocessor 112 of tablet 111 may provide a touch screen display emulation of joystick functions that, in response to touch inputs of a user, provide control inputs communicated by probe interface assembly (e.g., cable 125) to sensing probe 120 for control of DC motor unit 151. Alternatively, an actual joystick and interface to microprocessor 112 could be used. DC motor unit 151 may use the control inputs from the joystick for actuating movement of sensing probe 120. Sensor units 150 may include, for example, the magnetometer 141, gyro system 144 and accelerometer system 145 shown in FIGS. 6A and 6B. DC motor unit 151 may use inputs from sensor units 150 in coordination with inputs from the joystick control unit 113 and inputs from microprocessor 112. Sensor units 150 may also feed back information from sensing probe 120 to the monitoring unit 110.

The initial detection of breathing by the UWB sensor 1300 within its detection range of beam forming from probe head 132 can indicate the distance of the required search. The operator may view the display on tablet 111 that depicts the direction of sensing with respect to the operating unit (e.g., monitoring unit 110). By using the manual guiding tool, such as a joystick or joystick display 113, the sensor assembly (e.g., sensor head 132) which is mounted on a micro robot may move toward the detected subject. Meanwhile, the 3-dimensional (x-y-z) coordinates of the robot's position may be reflected in the display on the screen of tablet 111. As the robot carrying the sensor head 132 proceeds with movement toward the desired location, the processing unit 112 can compute the position of the detected person (subject 101) and verify that the robot is moving on a correct path. Deviation from the path can then be calculated based on the data from the UWB receiver 1308, magnetometer 141, accelerometer 144, and the gyroscope 145. If such deviation is less than a threshold level set in the program by the operator, the position of sensor probe head 132 is the closest one for the buried live person (subject 101) and the rescue operation can proceed.

FIG. 8 is a flow chart illustrating a method 800 for signal processing for guiding a sensor probe (e.g., sensing probe 120) through obstacles for searching for a subject (e.g., a victim 101), in accordance with an embodiment.

At step 801, method 800 may start with an initial incremental waypoint such as the GPS position of monitoring unit 110, with sensing probe 120 located near the unit to effectively start with the same waypoint position for the sensing probe 120. At step 802, the coordinates and timing of each incremental waypoint may be recorded and variables initialized. At each waypoint (j) (step 803), the UWB sensor provides the reflected power (Pj) pattern at its receiver (step 804). This pattern may be stored (database 806) in a file referred to as a “bin”. While the content of the reflected power is stored in a bin file (ψ(Pj)), a mathematical filtering (step 805) may be performed to identify number of the reflections (φ(Pj)). The filtering function φ(Pj) identifies the number of cluttering elements (e.g., reflections from various rubble 102 objects and obstacles) within the beam width range of the UWB sensor antenna system. Based on that analysis and calculating new location (step 807), the system provides an estimate of the trajectory and distance (Rj) required to get closer to the trapped person. At step 808, a 3-D imaging update may be performed, for example, to update an image such as that shown in FIGS. 9A-9E on a display device—such as the touch screen display of tablet 111 of a monitoring unit 110—for viewing by a remote operator. If such an increment to the person is met by the threshold value (εj) (step 809), then the 3-D coordinates may be used for a rescue operation (step 810).

FIGS. 9A, 9B, 9C, 9D, and 9E are illustrations of touch-screen image displays for a user interface of a sensor system 100 in accordance with one or more embodiments.

A 2-D display format, as seen in FIGS. 9A-9E, may be described as a display option that depicts one parameter (horizontal axis) vs. another (vertical axis), such as distance vs. time (histogram), or strength of the received signal vs. estimated depth. The depth can be estimated within the window of distance (range) that corresponds to the radiometer sensor's detection capability in air. It should be noted that the subject has been detected through air and multiple reflection paths (multipath reflections) from the transmitted signal. The sensing probe 120 does not employ the energy of sense-through-the-wall systems in which the radar signal actually travels through the wall or other material to find motion.

FIG. 9A illustrates a touch screen display of tablet 111 after detecting a person (subject 101) using the person's breathing and monitoring the person's presence for a period of time. The horizontal axis is the time and the vertical axis is the distance of the object from the sensor (sensing probe 120) in feet (ft.). The display of FIG. 9A indicates a person sitting and breathing 7.5 ft. away from the probe. The time lapse of the display along the horizontal axis from left to right is approximately 1 minute. The image of a person to the left side of the display may be processed from the UWB radiometer. A similar image also may be processed from LED array 121 and micro cameras 126 and provided on the display. The image processor (e.g., processing unit of monitoring unit 110, micro processor 112, or image processor 1346) may also combine (or fuse) the optical and radiometer data to provide an image display that may be enhanced (e.g., by selecting, zooming, and focus functions) and compared to either the radiometer image or optical image alone.

The sensor system 100 has an option of increasing sensitivity (touch screen button 2. shown on display of FIG. 9A) or decreasing sensitivity (touch screen button 3.) of detecting breathing from the UWB signals. The display unit has modes of operation that can be toggled, for example, using touch screen button 4. FIG. 9A shows one mode displaying history of detection for a period of one minute. A video of the detection operation can also be selected to view for post rescue operation training. By touching button 4, currently labeled “circle”, the mode can be toggled to that shown in FIG. 9B, in which touching button 5, labeled “wave” will toggle the mode to that shown in FIG. 9C, and so forth.

FIG. 9B illustrates a circle mode display after sensor system 100 may detect breathing of a trapped person by her/his chest displacement that is detected through the air (and not other material). Distance from sensor system 100 sensing probe 120 to the subject person may be displayed (horizontal axis) and may also be used to depict an artificially generated circle, such as seen in FIG. 9B. The size of the circle may be calculated based on the distance of the detected subject to give a perception of the size of the subject without actually measuring the actual size of the person.

FIG. 9C illustrates a wave mode display that is another option to display the detected breathing. Approximate distance from the probe has been identified (horizontal axis) and relative signal strength of the reflections may be seen compared to the vertical axis. The choice of circle (or dot) format vs. wave format has been illustrated, respectively, by FIG. 9B and FIG. 9C. These functions, as well as the sensitivity management, can be selected on the screen using the touchpad that is integrated with the tablet device 111 of monitoring unit 110. It should be noted that, using sensor system 100, the subject 101 is detected through air and multipath reflection from the transmitted and reflected signals; in other words, the subject 101 is detected using a sense-through-the-air (STTA) or radiometry system rather than a sense-through-the-wall (STTW) or radar system. The radiometry system detection is not the same as that employed by sense-through-the-wall systems where the signals travel through the actual wall or other material to detect motion.

FIG. 9D illustrates a display of triangulation of positions for multiple subjects 101 using multiple sensor systems 100. The multiple sensor systems 100 can be configured to enable connection of each of the individual sensor systems by wire or wirelessly. As shown in FIG. 1, the sensor monitoring units 110 may be placed on the ground and their sensing probes 120 may be inserted into the cracks and holes of the collapsed building after occurrence of an earthquake. The sensor probes 120 can provide triangulation of their respective sensed breathing position for each subject (due to the mutually exclusive coding of detection signals). The display of FIG. 9D may depict an estimated position of the neighboring sensor probes.

FIG. 9E illustrates a resulting determination from multiple sensor systems 100 of the number of the individuals (subjects 101) inside a volume of the collapsed building. The positions can also be overlaid on commercially available maps. As has been seen, by selecting a sensor (sensing probe 120), one can observe the surroundings of a detected trapped person. FIG. 9E depicts an overlay (with a generated grid for reference) of the sensed individuals (subjects 101) for the first responders on a map (such as a Google Maps® map).

FIG. 10 shows a graph of insertion loss (in dB) vs. frequency (in MHz) for a 16-by-16 LHCP antenna array, such as that shown in FIG. 5, operating in the W-band. FIG. 10 depicts S-parameters (e.g., a mathematical construct that quantifies how RF energy propagates through a multi-port network; for example, S11 may refer to the ratio of signal that reflects from port one for a signal incident on port one) for a 16-by-16 LHCP antenna array (e.g., similar to wafer scale antenna array 510 seen in FIG. 5) which operates around a center frequency of 95 GHz.

FIGS. 11A and 11B show co-polarization and cross polarization graphs for wafer scale, LHCP and RHCP antenna arrays (e.g., similar to wafer scale antenna array 510 seen in FIG. 5). FIG. 11A shows wafer scale beam forming of an LHCP array with left-hand circular polarization (co-polarization) beam 1101 and cross polarization 1102. As can be seen from the graph, beam width of better than 4 degrees can be obtained, with a 22 dB gain difference for cross polarization suppression of the RHCP wave 802.

FIG. 11B shows similar results for wafer scale beam forming of an RHCP array (e.g., similar to wafer scale antenna array 510 seen in FIG. 5) with right-hand circular polarization (co-polarization) beam 1103 and cross polarization (LHCP) 1104.

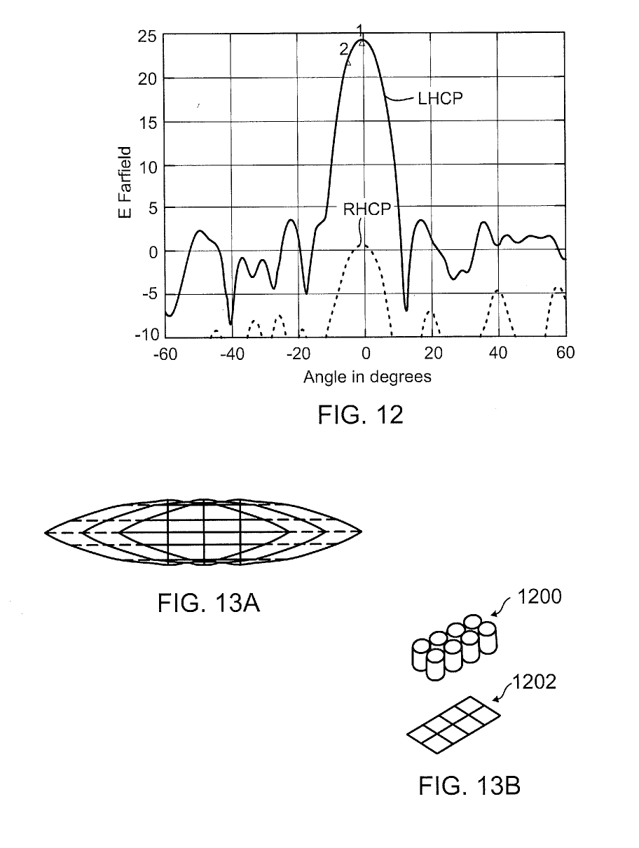

FIG. 12 shows a graph of an example of polarization and enhancement of side lobe suppression for a 4-by-4 element collimated antenna array. In one embodiment, an “out-of-phase squeezing” of the transmitted waves permits a smaller array to deliver similar gain, beam width, and polarization properties with substantially reduced number of array elements compared to a larger array such as a 256-element (8×8) antenna array and may reduce the need for integration of complex power amplifiers with the antenna array, reducing the integration level, power consumption, and cost. In one embodiment, the enhancement using “out-of-phase squeezing” may permit using a 4-by-4 element (16 antenna elements) or 8-by-8 elements (64 antenna element) array instead of, for example, the implementation of the 16-by-16 (256 antenna elements) antenna array. Such an antenna size reduction confers the capability to reduce various radiometer system sizes by a factor of 4 as well as packing alternating right-hand circularly polarized (RHCP) and left-hand circularly polarized (LHCP) 4-by-4 arrays in a planar surface to provide higher radiometer image resolution and phase contrast with minimal thickness of the arrays. In one embodiment, the side dimension of each 16-by-16 planar active antenna array 1325 may be less than 4.0 inches.

In addition, use of a separate wafer scale collimator layer 1200 (see FIG. 13B) that is separated from the antenna array by a certain distance may be implemented. Such a collimator may be implemented as a 4-by-4 array of Teflon based (e.g., εᵣ=2.0, where εᵣ is the relative permittivity of the material as opposed to the vacuum permittivity ε₀) collimators that produce a beam width of approximately 8.0 degrees and a gain of 24.4 dB with 24 dB cross polarization. The index of refraction (or permittivity) of the collimators can vary among various embodiments.

The graph in FIG. 12 shows co-polarization and cross-polarization of the LHCP radiation and RHCP radiation of the 4-by-4 array 1302 with Teflon wafer-scale collimator 1200 shown in FIG. 13B. The size of the 4-by-4 array 1202 operating at 95 GHz may be about 5.6 mm by 5.6 mm. FIG. 12 shows side lobes are below 3 dB with a better than 20 dB side lobe suppression compared to the 16-by-16 array 510 that has two strong side lobes at 12 dB. Suppression of side lobes may be a critical factor for clear radiometer imaging with high contrast and high antenna efficiency (e.g., greater than 95%).

FIG. 13A is a diagram showing a cross section of a collimator for an antenna array such as shown in FIG. 13B; and FIG. 13B is a perspective diagram of a collimator layer and a pair of 2-by-2 element collimated antenna arrays, in accordance with an embodiment. FIG. 13B depicts the implemented collimator 1200 at the position, relative to array 1202, of enhancing the gain and reducing side lobes. As shown in FIG. 13B, one 2-by-2 LHCP array and one 2-by-2 RHCP array may be integrated in the same substrate side by side. Spacing between the collimator 1200 and the array plates 1202 may be about 20 mm for a combination of collimator patterns with each protrusion upward and inward with effective radius of 20 mm and total thickness of 5 mm. Four double-sided protrusions may be placed atop of each 2-by-2 sub-array.

Embodiments described herein illustrate but do not limit the disclosure. It should also be understood that numerous modifications and variations are possible in accordance with the principles of the present disclosure. Accordingly, the scope of the disclosure is best defined by the following claims.

What is claimed is:

1. A system comprising:
a monitoring unit;
a sensing probe comprising an ultra wide band (UWB) antenna;
a cable connecting the UWB antenna to the monitoring unit such that the cable communicates a UWB signal between the UWB antenna and the monitoring unit;
a UWB radiometer sensor system configured to detect breathing of a subject;
an imaging processor of the monitoring unit in communication with the UWB radiometer sensor system and configured to calculate a position of the detected subject; and
a display of the monitoring unit configured to provide information about the position of the subject to an operator.

2. The system of claim 1, further comprising:
a second monitoring unit;
a second sensing probe;
a second a UWB radiometer sensor system, wherein:
the UWB signal of the UWB radiometer sensor system and a second UWB signal of the second UWB radiometer sensor system are mutually exclusively coded such that a first position calculation from the UWB signal and a second position calculation from the second UWB signal are made without interfering with each other; and
the imaging processor calculates a triangulated position of the subject using the first position calculation and the second position calculation.

3. The system of claim 1, further comprising:
a light emitting diode (LED) array included in the sensing probe; and
an optical camera included in the sensing probe and in communication with the imaging processor.

4. The system of claim 1, wherein:
the UWB antenna comprises a dipole antenna configured to propagate a cardioid radiation pattern.

5. The system of claim 1, further comprising:
a directional microphone having a cardioid sensitivity pattern, wherein:
the UWB antenna comprises a dipole antenna configured to propagate a cardioid radiation pattern; and
a direction of maximum sensitivity of the cardioid sensitivity pattern of the microphone is adjusted to overlap a direction of maximum propagation of the cardioid radiation pattern of the UWB antenna.

6. The system of claim 1, wherein:
the UWB antenna comprises a wafer scale antenna array.

7. The system of claim 1, wherein at least one of the sensors includes:
an antenna array comprising a left-hand circularly polarized (LHCP) antenna array in a planar surface.

8. The system of claim 1, further comprising:
a robot that carries the sensing probe 120 and is controllable from a joystick control unit at the monitoring unit.

9. The system of claim 1, further comprising:
a gyro system included in the sensing probe;
an accelerometer system included in the sensing probe; and
the image processor uses data from the gyro system, and the accelerometer system to calculate the position of the detected subject.

10. The system of claim 1, wherein:
the display includes a touch screen configured to accept input from an operator.

11. A method comprising:
configuring a sensing probe to include an ultra wide band (UWB) antenna;
connecting the UWB antenna to a monitoring unit such that a UWB signal is communicated between the UWB antenna and the monitoring unit;
detecting breathing of a subject using UWB radiometer sensor system comprising the UWB antenna;
processing data from the UWB radiometer sensor system;
calculating a position of the detected subject using the data; and
displaying the position of the detected subject relative to the sensing probe on a display of the monitoring unit.

12. The method of claim 11, further comprising:
processing a second data from a second UWB radiometer sensor system that uses a second UWB signal that is mutually exclusively coded with respect to the UWB signal;
calculating the position of the detected subject using the first data and the second data to provide a triangulated position of the detected subject; and
displaying the triangulated position of the detected subject on the display of the monitoring unit.

13. The method of claim 10, further comprising:
processing a second data from a second UWB radiometer sensor system that uses a second UWB signal that is transmitted from a second sensing probe and that is mutually exclusively coded with respect to the UWB signal;
displaying a position of the probe on the display of the monitoring unit; and
displaying a position of the second probe on the display of the monitoring unit.

14. The method of claim 11, further comprising:
lighting an area close to the sensing probe using a light emitting diode (LED) array mounted in the sensing probe; and
communicating an optical image of the lighted area to the monitoring unit using a camera mounted in the sensing probe.

15. The method of claim 11, further comprising:
detecting motion of the sensing probe using an accelerometer mounted in the sensing probe; and
communicating sensing probe motion data to the monitoring unit.

16. The method of claim 11, further comprising:
calculating a position of the sensing probe using an initial global positioning system (GPS) position of the sensing probe and accelerometer data and angular velocity data provided from an accelerometer system mounted in the sensing probe and a gyro system mounted in the sensing probe.

17. The method of claim 11, further comprising:
controlling movement of the sensing probe from the monitoring unit using a joystick control unit; and
controlling the movement based on position data received from the sensing probe using an accelerometer system mounted in the sensing probe and a gyro system mounted in the sensing probe

18. The method of claim 11, further comprising:
propagating the UWB signal in a cardioid radiation pattern to provide a directional detection of the subject from a dipole antenna.

19. The method of claim 11, further comprising:
propagating the UWB signal from a wafer scale antenna array using spatial power combining and beam forming to provide a directional detection of the subject.
